(19) United States
(12) Patent Application Publication
(10) Pub. No.: US 2026/0091432 A1
(43) Pub. Date: Apr. 2, 2026

(54) CUTTER HOLDER ASSEMBLY WITH JOINT CONNECTOR

(71) Applicant: SHIN-YAIN INDUSTRIAL CO., LTD., Taichung City (TW)

(72) Inventor: PEN HUNG CHEN, Taichung City (TW)

(73) Assignee: SHIN-YAIN INDUSTRIAL CO., LTD., Taichung City (TW)

(21) Appl. No.: 18/903,294

(22) Filed: Oct. 1, 2024

(51) Int. Cl. B23B 27/12

(52) U.S. Cl. CPC B23B 27/12; B23B 2240/00; B23B 2260/106

(57) ABSTRACT

A cutter holder assembly has a cutter holder, a cutting unit, a joint connector, and a nut. The cutter holder has a receiving hole, a conical hole, and a connection hole disposed therein and communicating with one another. The cutting unit has an assembling portion inserted in the conical hole, an engaging hole being polygonal, an extension pole extending from the assembling portion, and at least one machining tool assembled to the extension pole. The joint connector is disposed in the receiving hole and has a connection section threaded within the connection hole and an engaging section engaging with the engaging hole. The nut is connected to the cutter holder. Wherein, the joint connector is fixed within the cutter holder and engages with the cutting unit to firmly connect the cutter holder and the cutting unit and to promote machining efficiency and quality of the cutter holder assembly.

### BACKGROUND OF THE INVENTION

### 1. Field of the Invention

The present invention relates to an accessory of a machining apparatus, and more particularly to a cutter holder assembly with a joint connector.

### 2. Description of Related Art

To cut or drill a workpiece, a cutter is driven by a spindle to machine the workpiece. A cutter holder is deployed between the cutter and the spindle for connection therebetween.

A conventional cutter holder assembly has a cutter holder and a cutting unit. Wherein, the cutting unit is a rod with two opposite ends. A cutter is disposed at one of the two ends of the cutting unit. The other one of the two ends of the cutting unit is fixed inside the cutter holder. However, when the cutting unit and the cutter holder are driven to cut or to drill the work piece, a strong resistant force is applied to the cutting unit and the cutter holder, making the cutting unit and the cutter holder prone to rotate relative to each other.

The cutting unit and the cutter holder that easily rotate relative to each other cause inefficiency of machining and even lead to a negative effect on the workpiece.

To overcome the shortcomings of the conventional cutter holder assembly, the present invention provides a cutter holder assembly with a joint connector to mitigate or obviate the aforementioned problems.

### SUMMARY OF THE INVENTION

The main objective of the present invention is to provide a cutter holder assembly with a joint connector that can firmly combine a cutting unit and a cutter holder thereof.

The cutter holder assembly has a cutter holder, a cutting unit, a joint connector, and a nut. The cutter holder has a receiving hole, a conical hole, and a connection hole disposed therein and communicating with one another. The cutting unit has an assembling portion inserted in the conical hole, an engaging hole being polygonal, an extension pole extending from the assembling portion, and at least one machining tool assembled to the extension pole. The joint connector is disposed in the receiving hole and has a connection section threaded within the connection hole and an engaging section engaging with the engaging hole. The nut is connected to the cutter holder. Wherein, the joint connector is fixed within the cutter holder and engages with the cutting unit to firmly connect the cutter holder and the cutting unit and to promote machining efficiency and quality of the cutter holder assembly.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a cutter holder assembly in accordance with the present invention;

FIG. 2 is an exploded perspective view of the cutter holder assembly in FIG. 1;

FIG. 3 is a perspective view of a joint connector of the cutter holder assembly in FIG. 1;

FIG. 4 is a side view of the cutter holder assembly in FIG. 1;

FIG. 5 is an enlarged side view in partial section of the cutter holder assembly in FIG. 1;

FIG. 6 is a cross-sectional end view of the cutter holder assembly across line 6-6 in FIG. 5;

FIG. 7 is a partially exploded perspective view of the cutter holder assembly in FIG. 1;

FIG. 8 is a partially exploded perspective view of a second embodiment of the cutter holder assembly in accordance with the present invention;

FIG. 9 is a partially exploded perspective view of a third embodiment of the cutter holder assembly in accordance with the present invention;

FIG. 10 is a partially exploded view of the fourth embodiment of the cutter holder assembly in accordance with the present invention;

FIG. 11 is a cross-sectional end view of the cutter holder assembly in FIG. 8; and

FIG. 12 is a cross-sectional end view of the cutter holder assembly in FIG. 9.

### DETAILED DESCRIPTION OF PREFERRED EMBODIMENTS

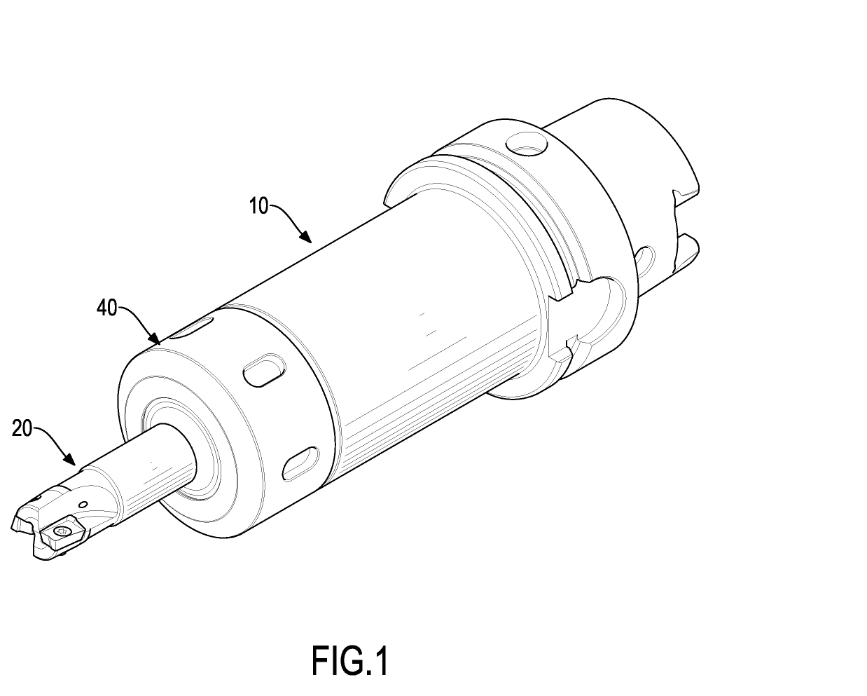

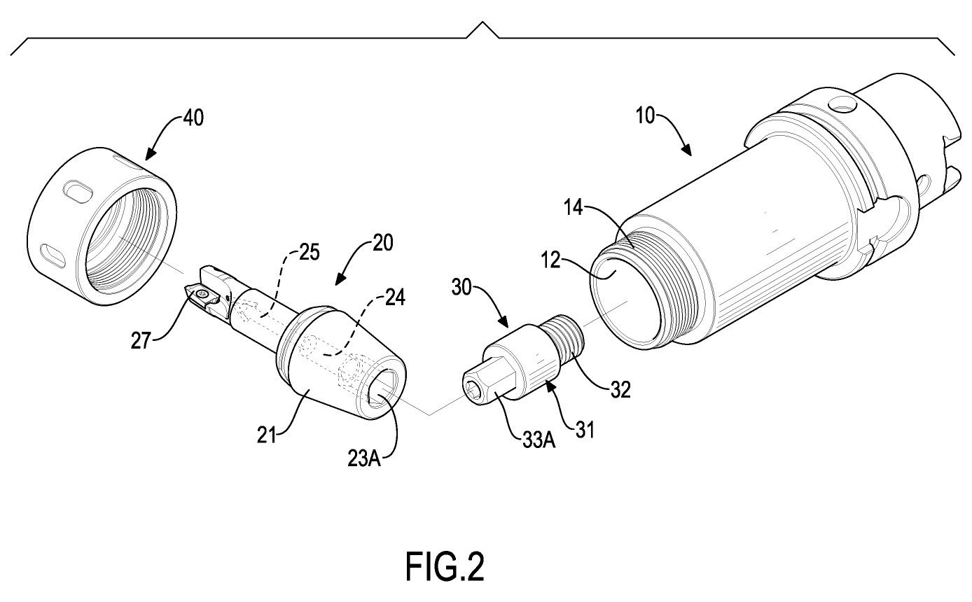

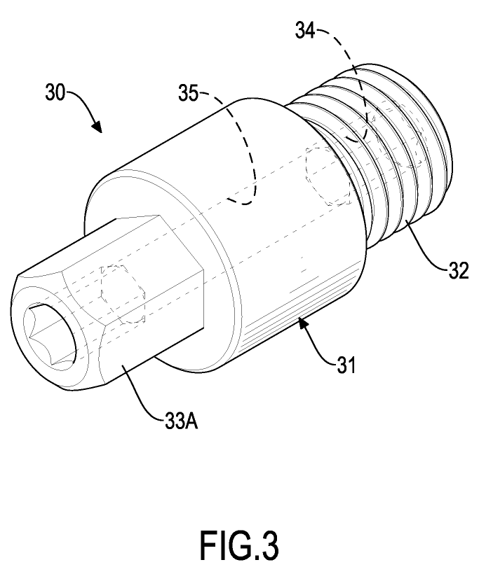

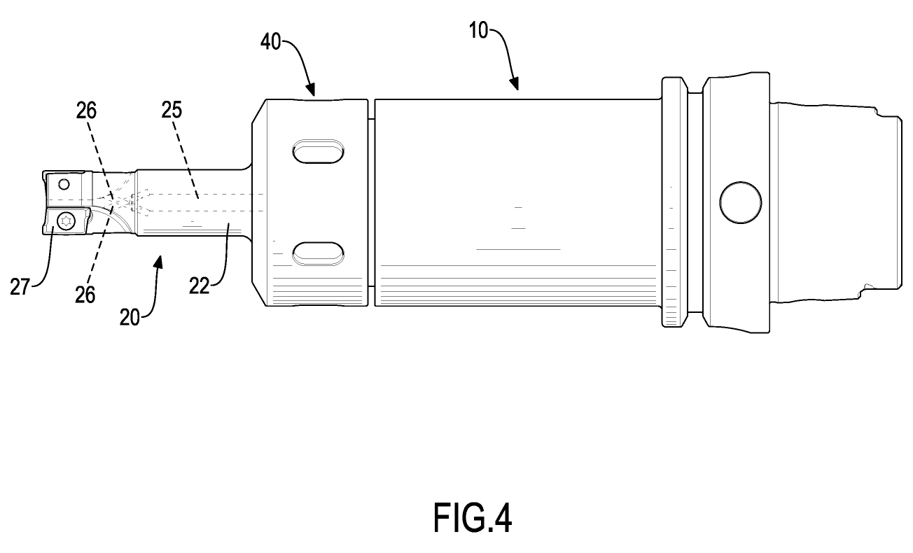

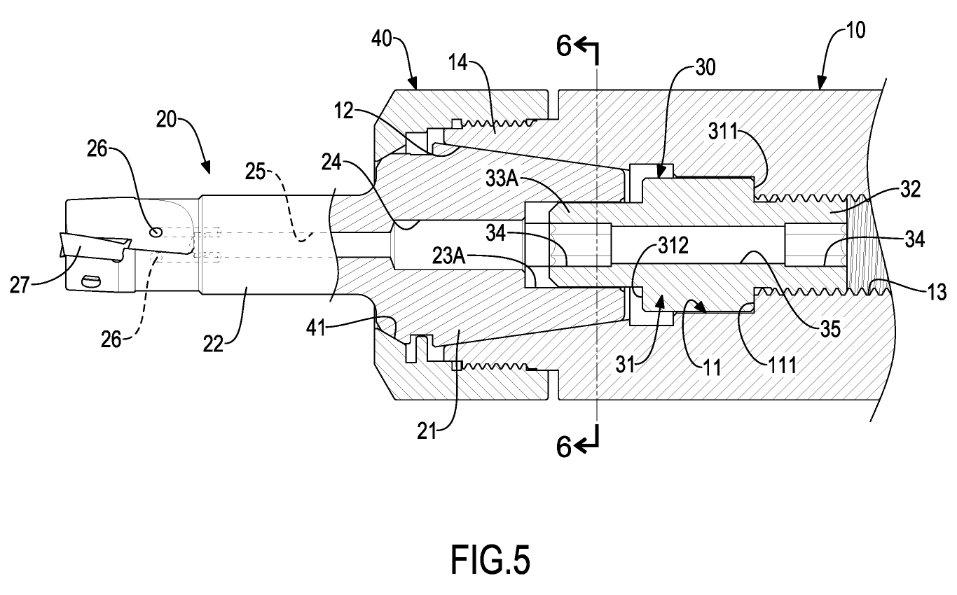

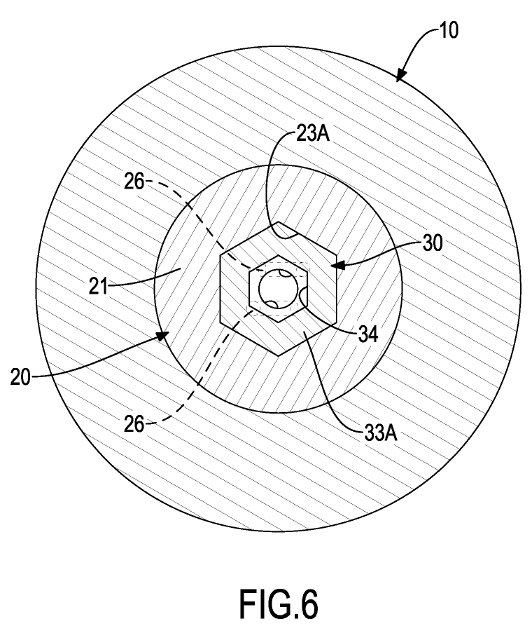

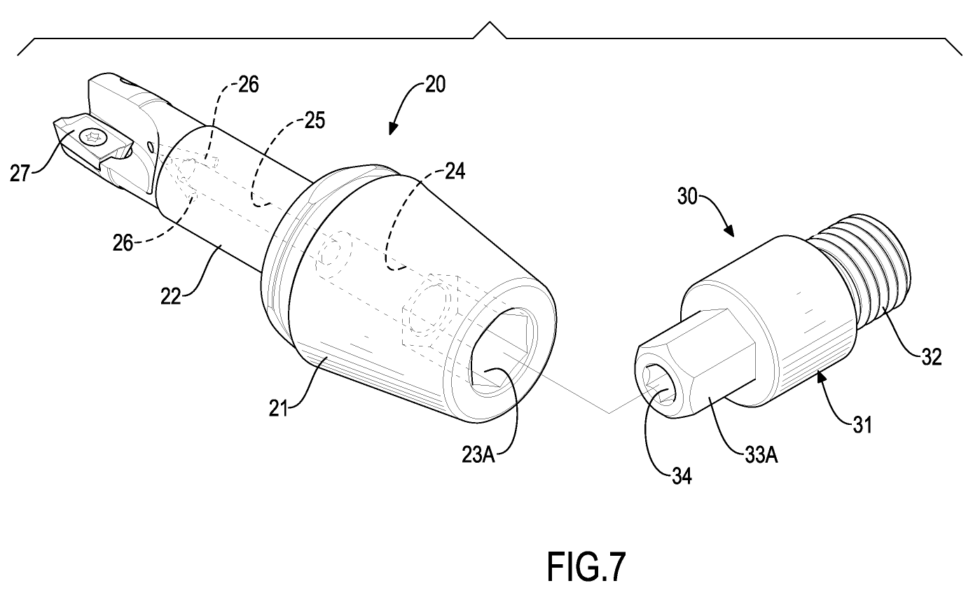

With reference to FIGS. 1 to 7, a cutter holder assembly in accordance with the present invention has a cutter holder 10, a cutting unit 20, a joint connector 30, and a nut 40.

With reference to FIGS. 1 to 7, the cutter holder 10 has two opposite ends, a receiving hole 11, a conical hole 12, a connection hole 13, and a mounting section 14. Wherein, the receiving hole 11 is disposed inside of the cutter holder 10 and has a bottom face 111. The conical hole 12 extends from one of the two ends of the cutter holder 10 to the receiving hole 11 and communicates with the receiving hole 11. A diameter of the conical hole 12 gradually decreases toward the receiving hole 12. The connection hole 13 extends from the other end of the two ends of the cutter holder 10 to the bottom face 111 of the receiving hole 11. The connection hole 13 communicates with the receiving hole and has an internal thread. The mounting section 14 and the conical hole 12 are disposed at a same end of the cutter holder 10. The mounting section 14 has an external thread.

With reference to FIGS. 1 to 7, the cutting unit 20 has an assembling portion 21, an extension pole 22, an engaging hole 23A, an inlet channel 24, a communicating channel 25, two outlet channels 26, and two machining tools 27. Wherein, the assembling portion 21 is conical and has a pressed end and an insertion end opposite each other in position. The insertion end is inserted into the conical hole 12. A diameter of the assembling portion 21 gradually reduces from the pressed end toward the insertion end of the assembling portion 21. The extension pole 22 extends from the pressed end of the assembling portion 21 and has a machining end away from the assembling portion 21. The engaging hole 23A extends from the insertion end toward the pressed end and has an outline being polygonal. The inlet channel 24 extends from a bottom of the engaging hole 23A toward the machining end of the extension pole 22. The communicating channel 25 fluidly communicates with the inlet channel 24 and extends toward the machining end of the extension pole 22. The two outlet channels 26 are disposed adjacent to the machining end of the extension pole 22 and fluidly communicate with the communicating channel 25. The two machining tools 27 are assembled at the machining end of the extension pole 22.

With reference to FIGS. 1 to 7, the engaging hole 23A, the inlet channel 24, and the communicating channel 25 are fluidly communicating with one another coaxially.

With reference to FIGS. 1 to 7, the joint connector 30 is disposed within the cutter holder 10 and has an abutting block 31, a connection section 32, an engaging section 33A, two key holes 34, and a communicating hole 35. The abutting block 31 is disposed inside the receiving hole 10 and is a block with a first end face 311 and a second end face 312 opposite each other in position. The connection section 32 is disposed at the first end face 311 and has an external thread. The connection section 32 is threaded within the connection hole 13 of the cutter holder 10 and makes the first end face 311 of the abutting block 31 abut against the bottom face 111 of the receiving hole 11.

With reference to FIGS. 1 to 7, the engaging section 33A is disposed at the second end face 312 of the abutting block 31 and has a cross section being polygonal. The engaging section 33A is inserted in the engaging hole 23A of the cutting unit 20. The two key holes 34 are respectively disposed within the connection section 32 and the engaging section 33A and respectively extend along the connection section 32 and the engaging section 33A. Each one of the two key holes 34 has an outline being polygonal. In the embodiment of the present invention, the outline of each key hole 34 corresponds to a hexagonal key in shape to be hexagonal. The hexagonal key can be inserted in one of the two key holes 34 to assemble or to remove the joint connector 30. The communicating hole 35 is disposed within the abutting block 31 and fluidly communicating with the two key holes 34 coaxially.

With reference to FIGS. 1 to 7, in the present invention, an outer diameter is smaller than a diameter of the receiving hole 11 to make the connection section 32 smoothly screwed with the connection hole 13 of the cutter holder 10. The first end face 311 of the abutting block 31 abuts against the bottom face 111 of the receiving hole 11 accordingly. A gap is formed between the insertion end of the assembling portion 21 of the cutting unit 20 and the second end face 312 of the abutting block 31 of the joint connector 30 consequently.

With reference to FIGS. 1 to 7, in the first embodiment of the present invention, the engaging section 33A of the joint connector 30 has a cross section being hexagonal. The outline of the engaging hole 23A of the cutting unit 20 corresponds to the cross section of the engaging section 33A in shape to be hexagonal. Therefore, the engaging section 33A and the engaging hole 23A are engageable.

With reference to FIGS. 1 to 7, the nut 40 has an internal thread and a through hole 41. The nut 40 is screwed to the mounting section 14. The mounting section 14 abuts against the pressed end of the assembling portion 21. Wherein, the extension rod 22 and the two machining tools 27 protrude out from the through hole 41 of the nut 40.

Compared with the conventional cutter holder assembly, the joint connector 30 of the present invention is fixed in the cutter holder 10 and has the engaging section 33A with the polygonal cross section, and the assembling portion 21 of the cutting unit 20 has the engaging hole 23A with the outline being polygonal. With the engagement between the engaging section 33A and the engaging hole 23A, the cutter holder 10 and the cutting unit 20 are free from rotating relative to each other. Accordingly, the cutting unit 20 can resist the reaction force from a workpiece being machined. Therefore, the cutter holder assembly promotes the efficiency of machining and the machining quality of the workpiece.

In addition, liquid coolant is conducted and flows via the communicating hole 35 of the joint connector 30, the inlet channel 24, the communicating channel 25, and the two inlet channels 26 for cooling the two machining tools 27.

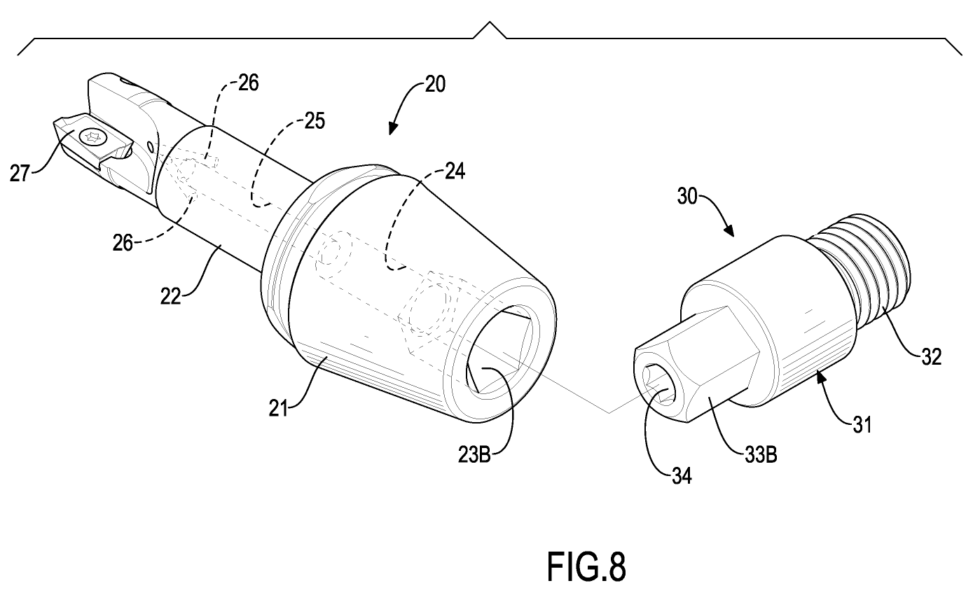

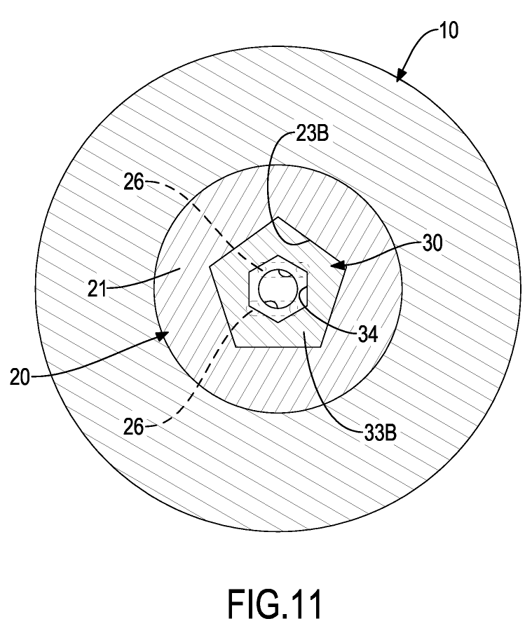

With reference to FIGS. 8 and 11, the second embodiment is similar to the first embodiment. Difference between the second and the first embodiments is: in the second embodiment, the cross section of the engaging section 33B of the joint connector 30 and the outline of the engaging hole 23B of the cutting unit 20 are both pentagonal correspondingly. The engaging section 33B and the engaging hole 23B can engage mutually to make the cutting unit 20 firmly connected to the cutter holder 10 and make the present invention process machining steadily and efficiently.

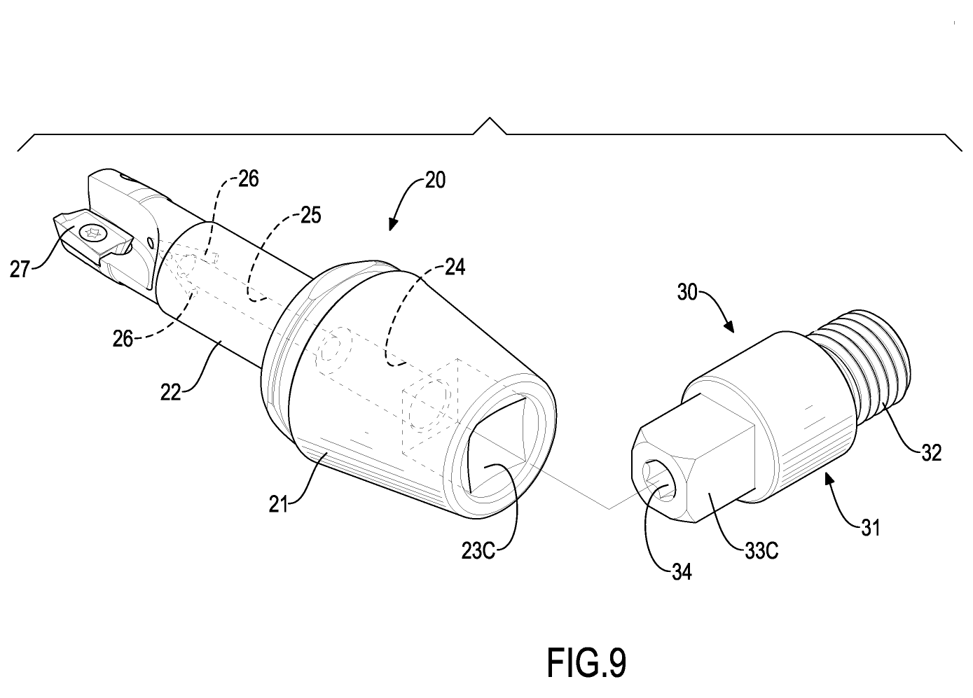

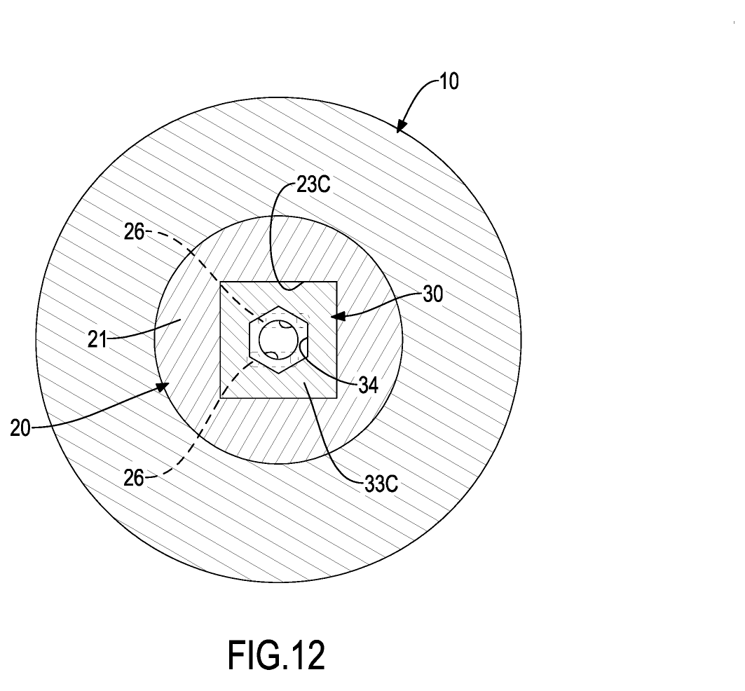

With reference to FIGS. 9 and 12, the third embodiment is similar to the first and second embodiments. The third embodiment differs fromthe first and the second embodiments in that: in the third embodiment, the cross section of the engaging section 33C of the joint connector 30 and the outline of the engaging hole 23C of the cutting unit 20 are both quadrilateral correspondingly. The engaging section 33C and the engaging hole 23C can engage mutually as well. Steady and efficient machining by the present invention is also achieved.

Practically, as long as the engaging section 33A, 33B, 33C and the engaging hole 23A, 23B, 23C can engage mutually, the cross section of the engaging section 33A, 33B, 33C of the joint connector 30 and the outline of the engaging hole 23A, 23B, 23C of the cutting unit 20 are not restricted.

In the first, second, and third embodiments of the present invention, each one of the two machining tools 27 is a cutter for machining.

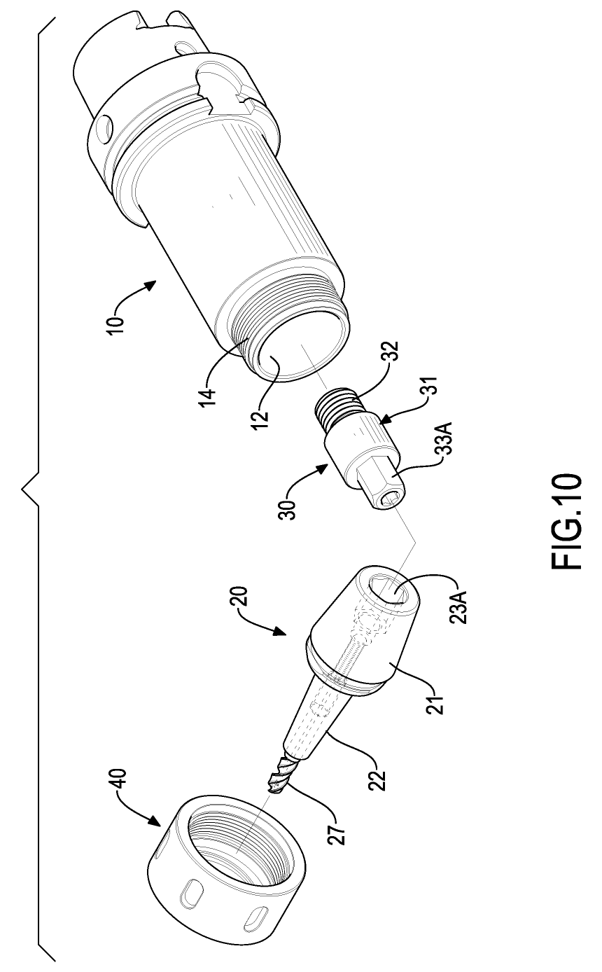

With reference to FIG. 10, the fourth embodiment is similar to the first embodiment. Difference between the fourth and the first embodiments is: in the fourth embodiment, the extension pole 22 of the cutting unit 20 is a conical slim pole and has a diameter gradually decreasing toward the machining end of the extension pole 22. In addition, one said machining tool 27 assembled to the extension pole 22 is a drill.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

WHAT IS CLAIMED IS:

1. A cutter holder assembly comprising:
a cutter holder having
two opposite ends;
a receiving hole disposed inside of the cutter holder and having a bottom face;
a conical hole extending from one of the two ends of the cutter holder to the receiving hole, communicating with the receiving hole, and having a diameter gradually decreasing toward the receiving hole; and
a connection hole extending from the other one of the two ends of the cutter holder to the bottom face of the receiving hole, communicating with the receiving hole, and having an internal thread;
a cutting unit having
an assembling portion being conical and having
a pressed end;
an insertion end opposite to the pressed end and inserted in the conical hole;
a diameter gradually decreasing from the pressed end toward the insertion end;
an engaging hole extending from the insertion end toward the pressed end and having an outline being polygonal;
an extension pole extending from the pressed end and having a machining end away from the assembling portion; and
at least one machining tool assembled at the machining end;
a joint connector disposed inside the cutter holder and having
an abutting block disposed inside the receiving hole, being a block with a first end face and a second end face opposite to each other, and having a diameter smaller than the diameter of the receiving hole;
a connection section disposed at the first end face, having an external thread, and threaded within the connection hole; and
an engaging section disposed at the second end face and having a cross section being polygonal, inserted in the engaging hole, and engaging with the engaging hole; and
a nut connected to the cutter holder, abutting against the pressed end and having a through hole, wherein the extension pole and the at least one machining tool protrude out from the through hole.

2. The cutter holder assembly as claimed in claim 1, wherein
the joint connector has two key holes respectively disposed within the connection section and the engaging section, and respectively extending along the connection section and the engaging section; and
each key hole has an outline being polygonal.

3. The cutter holder assembly as claimed in claim 2, wherein the outline of each one of the two key holes is hexagonal.

4. The cutter holder assembly as claimed in claim 3, wherein
the cutting unit has
an inlet channel extending from a bottom of the engaging hole toward the machining end;
a communicating channel fluidly communicating with the inlet channel and extending toward the machining end;
two outlet channels adjacent to the machining end and fluidly communicating with the communicating channel; and
the joint connector has a communicating hole disposed inside the abutting block and fluidly communicating with the two key holes.

5. The cutter holder assembly as claimed in claim 4, wherein each one of the at least one machining tool is a cutter.

6. The cutter holder assembly as claimed in claim 5, wherein
the cutter holder has a mounting section disposed at a same end of the cutter holder with the conical hole and having an external thread; and
the nut has an internal thread and is screwed with the mounting section.

7. The cutter holder assembly as claimed in claim 1, wherein the extension pole is a conical slim pole and has a diameter gradually decreasing toward the machining end of the extension pole.

8. The cutter holder assembly as claimed in claim 1, wherein
the cross section of the engaging section is hexagonal; and
the outline of the engaging hole corresponds to the cross section of the engaging section and is hexagonal.

9. The cutter holder assembly as claimed in claim 3, wherein
the cross section of the engaging section is hexagonal; and
the outline of the engaging hole corresponds to the cross section of the engaging section and is hexagonal.

10. The cutter holder assembly as claimed in claim 4, wherein
the cross section of the engaging section is hexagonal; and
the outline of the engaging hole corresponds to the cross section of the engaging section and is hexagonal.

11. The cutter holder assembly as claimed in claim 6, wherein
the cross section of the engaging section is hexagonal; and
the outline of the engaging hole corresponds to the cross section of the engaging section and is hexagonal.

12. The cutter holder assembly as claimed in claim 7, wherein
the cross section of the engaging section is hexagonal; and
the outline of the engaging hole corresponds to the cross section of the engaging section and is hexagonal.

13. The cutter holder assembly as claimed in claim 1, wherein
the cross section of the engaging section is pentagonal; and
the outline of the engaging hole corresponds to the cross section of the engaging section and is pentagonal.

14. The cutter holder assembly as claimed in claim 3, wherein
the cross section of the engaging section is pentagonal; and
the outline of the engaging hole corresponds to the cross section of the engaging section and is pentagonal.

15. The cutter holder assembly as claimed in claim 6, wherein
the cross section of the engaging section is pentagonal; and
the outline of the engaging hole corresponds to the cross section of the engaging section and is pentagonal.

16. The cutter holder assembly as claimed in claim 7, wherein
the cross section of the engaging section is pentagonal; and
the outline of the engaging hole corresponds to the cross section of the engaging section and is pentagonal.

17. The cutter holder assembly as claimed in claim 1, wherein
the cross section of the engaging section is quadrilateral; and
the outline of the engaging hole corresponds to the cross section of the engaging section and is quadrilateral.

18. The cutter holder assembly as claimed in claim 3, wherein
the cross section of the engaging section is quadrilateral; and
the outline of the engaging hole corresponds to the cross section of the engaging section and is quadrilateral.

19. The cutter holder assembly as claimed in claim 6, wherein
the cross section of the engaging section is quadrilateral; and
the outline of the engaging hole corresponds to the cross section of the engaging section and is quadrilateral.

20. The cutter holder assembly as claimed in claim 7, wherein
the cross section of the engaging section is quadrilateral; and
the outline of the engaging hole corresponds to the cross section of the engaging section and is quadrilateral.
